(19) United States
(12) Patent Application Publication
(10) Pub. No.: US 2005/0158096 A1
(43) Pub. Date: Jul. 21, 2005

(54) Multifuctional device

(76) Inventors: Sang-Cheol Park, Suwon-si (KR); Byung-sun Ahn, Suwon-si (KR); Young-min Kim, Suwon-si (KR)

Correspondence Address: STANZIONE & KIM, LLP, 1740 N STREET, N.W., FIRST FLOOR, WASHINGTON, DC, 20036, US

(21) Appl. No.: 11/022,761

(22) Filed: Dec. 28, 2004

(30) Foreign Application Priority Data
Jan. 16, 2004 (KR) 2004-3252

(51) Int. Cl. G03G 15/00

(52) U.S. Cl. 399/405

(57) ABSTRACT

A multifunctional device including an image reading unit to read documents, a printer including an accumulating unit on which printing media with images formed by a developing unit are accumulated, and an emitting unit which emits heat generated from the developing unit, and a ventilator which is installed in the accumulating unit and connected to an inside of the printer. In the device, heat generated from the printing media is emitted via the ventilator so that the heat is not transferred to the image reading unit.

### CROSS-REFERENCE TO RELATED APPLICATIONS

This application claims the priority of Korean Patent Application No. 2004-3252, filed on Jan. 16, 2004 in the Korean Intellectual Property Office, the disclosure of which is incorporated herein in its entirety by reference.

### BACKGROUND OF THE INVENTION

1. Field of the Invention

The present general inventive concept relates to a multifunctional device, and more particularly, to a multifunctional device, which emits heat of printing papers accumulated on a discharge support.

2. Description of the Related Art

Generally, a multifunctional device is an apparatus having the functions of at least two among a scanner, a facsimile, and a printer. Although the multifunctional device can have various configurations, a typical multifunctional device includes a scanner disposed at an uppermost position thereof for scanning documents to read images. An image sensor of the scanner irradiates rays to the documents supplied from an automatic paper feeding unit to read the images.

Also, a printer is positioned at a lower portion of the multifunctional device and prints the images read from the scanner on printing media or prints other images on the printing media in response to other signals. This printer can be used in an ink-jet method or a laser scanning unit method.

The printing media on which the images are formed by the foregoing methods are discharged and accumulated on an accumulating unit. This accumulating unit is positioned at an upper portion of the printer, i.e., directly under the scanner.

However, the printing media accumulated on the accumulating unit are heated and pressurized during the printing of the images. Thus, the printing media are not only heated to quite a high temperature themselves, but also heat emitted therefrom is transferred to the scanner positioned directly thereon, thereby transforming components of the scanner.

If the components of the scanner are transformed by the heat emitted from the printing media, a read function, such as a focal distance, can be deteriorated when the documents are read, so that the read images may become dim or brightness may be degraded.

Further, as a size of multifunctional devices is reduced, it is required to minimize a paper discharge space between the scanner and the printer. Thus, since the printing media accumulated on the discharge support become closer to the scanner, the foregoing problems become more serious.

Therefore, an apparatus for emitting heat of the printing media accumulated on the discharge support is needed to prevent the heat from being transferred to the scanner.

### SUMMARY OF THE INVENTION

The present general inventive concept provides a multifunctional device, which lowers a temperature of an accumulating unit by discharging heat emitted from printing media so as to prevent a malfunction of a scanner.

Additional aspects and advantages of the present general inventive concept will be set forth in part in the description which follows and, in part, will be obvious from the description, or may be learned by practice of the general inventive concept.

The foregoing and advantages of the present general inventive concept are achieved by providing a multifunctional device comprising an image reading unit to read documents, a printer including an accumulating unit on which printing media with images formed by a developing unit are accumulated, and an emitting unit which emits heat generated from the developing unit, and a ventilator, which is installed in the accumulating unit and connected to an inside of the printer. In this device, heat generated from the printing media are emitted via the ventilator so that the heat is not transferred to the scanner.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view of a multifunctional device according to the present general inventive concept;

FIG. 2 is a side view of a monitor of the multifunctional device of FIG. 1;

FIG. 3 is a front view of the multifunctional device of FIG. 1;

FIG. 4 is a perspective view of the multifunctional device of FIG. 1; and

FIG. 5 is a side view of a multifunctional device adopting a ventilator according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

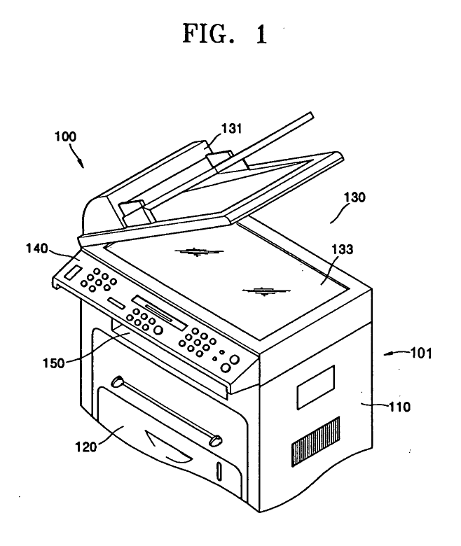

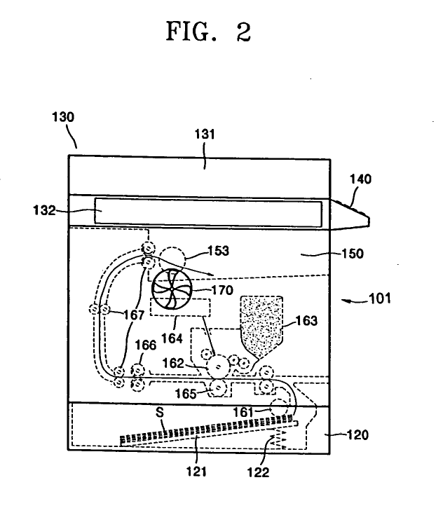

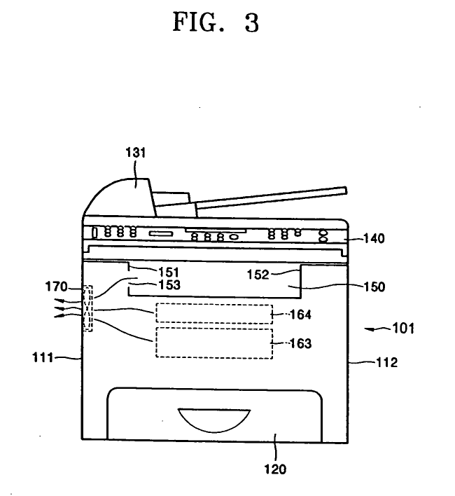

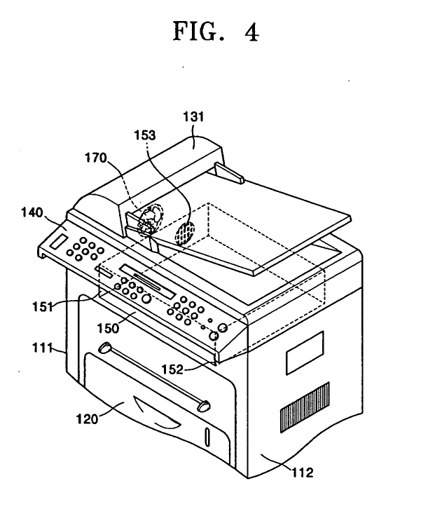

Referring to FIGS. 1 through 4, a multifunctional device 100 includes a scanner (or image reading unit) 130, a printer 110, and an operating panel 140. The scanner 130 reads images formed on documents, and the printer 110 prints the images. The operating panel 140 is used to operate the scanner 130 and the printer 110.

The scanner 130 is positioned on the printer 110 and includes an automatic document feeding unit 131 and an image sensor 132. The automatic document feeding unit 131 is rotarably installed upward and automatically feeds the documents. The image sensor 132 is slidably installed under a glass plate 133 installed below the automatic document feeding unit 131 and reads the images formed on the documents by irradiating rays to the documents.

The printer 110 is installed in a main body 101 and includes an exposing unit 164, a developing unit 163, a transfer roller 165, and a fixing unit 166. The exposing unit 164 forms electrostatic latent images using predetermined electric potentials by irradiating rays on a photosensitive medium 162. The developing unit 163 supplies a toner to the electrostatic latent images formed on the photosensitive medium 162 and forms predetermined images. The transfer roller 165 transfers the images formed on the photosensitive medium 162 to a printing medium S. The fixing unit 166 applies heat and pressure to the images formed on the printing medium S and fixes the images to the printing medium S.

A cassette 120 is installed below the main body 101 so as to be capable of accumulating the printing medium S and being loaded on or unloaded from the device 100. The cassette 120 is elastically biased upward by a spring 122 and includes a supporting plate 121 on which the printing medium S is loaded.

A pickup roller 161 is installed at an upper portion of the cassette 120 in the main body 101 so as to contact and pick up the printing medium S.

While passing the photosensitive medium 162 and a contact portion of the image transfer roller 165, the printing medium S that is picked up by the pickup roller 161 receives the images from the photosensitive medium 162. Also, while passing the fixing unit 166, the printing medium S is heated and pressurized such that the images are fixed to the printing medium S. The printing medium S to which the images are fixed is discharged by a plurality of discharge rollers 167 and accumulated on an accumulating unit 150.

An emitting unit 170 is installed on an external case 111 of the main body 101 and emits heat generated from the exposing unit 164 and the developing unit 163. The emitting unit 170 may be formed of a fan.

Accordingly, as the emitting unit 170 (i.e., the fan) rotates, heat generated from the exposing unit 164 and the developing unit 163 is emitted out of the main body 101 through an opening formed on the external case 111 so as to prevent an inside of the main body 101 from overheating.

The emitting unit 170 is not necessarily installed on the external case 111. Instead, the emitting unit 170 may be installed on another external case 112 opposite to the external case 111 with respect to the exposing unit 164 and the developing unit 163.

The accumulating unit 150 has a predetermined space where printing media S with the images formed are discharged and accumulated and is surrounded by sidewalls 151 and 152 and covered by the scanner 130. However, a portion of the accumulating unit 150 is exposed so that a user can take the accumulated printing media S.

A ventilator 153 is formed on the sidewall 151 and connected to the inside of the main body 101. Thus, as the emitting unit 170 (i.e., the fan) rotates, the heat generated from the printing media S accumulated on the accumulating unit 150 is emitted through the ventilator 153, the inside of the main body 101, and the fan 170 out of the main body 101.

The ventilator 153 can be formed opposite to the emitting unit 170 such that the heat generated from the accumulating unit 150 is emitted through the ventilator 153 and the emitting unit 170. Therefore, when the emitting unit 170 is installed on the external case 112, the ventilator 153 can be formed on the sidewall 152 that is opposite to the external case 112.

The ventilator 153 can be formed on each of the sidewalls 151 and 152, and also the emitting unit 170 can be installed on each of the external cases 111 and 112.

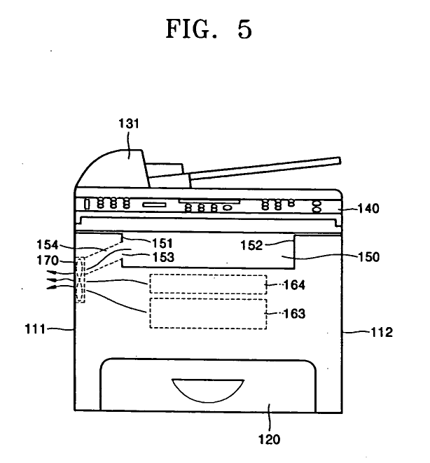

Referring to FIG. 5, the configuration of a multifunctional device is similar to that of FIGS. 1 through 4 except that a guiding unit 154 is further installed between the emitting unit 170 and the ventilator 153 in order to connect the ventilator 153 to the emitting unit 170 and guide a flow of air. As long as the guiding unit 154 can guide the flow of air by connecting the ventilator 153 to the emitting unit 170, a variety of modified examples can be used instead of the guiding unit 154 shown in FIG. 5. The guiding unit 154 can have a cylindrical shape.

As described above, the present general inventive concept provides the multifunctional device to forcibly emit heat generated from the printing media accumulated on an accumulating unit, thus preventing a malfunction of the device.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A multifunctional device comprising:
an image reading unit to read images from documents;
a printer including a developing unit, an accumulating unit on which printing media with the read images formed by the developing unit are accumulated, and an emitting unit which emits heat generated from the developing unit; and
a ventilator which is installed in the accumulating unit and connected to an inside of the printer,
wherein heat generated from the printing media is emitted via the ventilator so that the heat is not transferred to the image reading unit.

2. The device of claim 1, wherein the printer comprises a sidewall to define the accumulating unit, and the ventilator is installed on the sidewall of the accumulating unit.

3. The device of claim 2, wherein the ventilator is installed on the sidewall of the accumulating unit which is disposed opposite to the emitting unit with respect to the inside of the printer.

4. The device of claim 1, further comprising:
a guiding unit which is installed in the printer and connects the ventilator to the emitting unit,
wherein the heat generated from the printing media is directly guided to the emitting unit by the guiding unit.

5. The device of claim 4, wherein the guiding unit has a cylindrical shape.

6. A multifunctional device comprising:
an image reading unit to read an image from a document;
a printer including a main body, a developing unit disposed in the main body to form the read image on one or more printing media, an accumulating unit formed on the main body and disposed between the image reading unit and the main body to receive the one or more printing media discharged from the main body, and an emitting unit to emit a first air containing a first heat generated from the developing unit outside the main body; and
a ventilator installed on the accumulating unit to guide a second air containing a second heat generated from the one or more printing media of the accumulating unit to the emitting unit so that the second air is emitted outside the main body by the emitting unit together with the first air.

7. The device of claim 6, wherein:
the main body comprises external cases and a top case coupled to the image reading unit;
the top case comprises sidewalls and a base to define the accumulating unit with a side of the image reading unit; and
the ventilator is installed on one of the sidewalls.

8. The device of claim 7, wherein the one of the sidewalls is disposed adjacent to the emitting unit, and the other one of the sidewalls is disposed opposite to the emitting unit with respect to the one of the sidewalls.

9. The device of claim 7, wherein the sidewalls of the accumulating unit are disposed between the external cases, and the ventilator and the emitting unit are installed on adjacent ones of the sidewalls and the external cases, respectively.

10. The device of claim 7, wherein the printer discharges the one or more printing media in a first direction parallel to the sidewalls, and the ventilator is disposed in a second direction perpendicular to the first direction.

11. The device of claim 7, wherein the printer feeds the one or more printing media in a first direction parallel to the sidewalls during forming the image on the one or more printing media, and the ventilator guides the air in a second direction perpendicular to the first direction.

12. The device of claim 6, further comprising:
a guide unit disposed in the main body to guide the second air from the ventilator to the emitting unit.

13. The device of claim 6, further comprising:
a guide unit extended from the ventilator toward the emitting unit to guide the air from the ventilator to the emitting unit.

14. The device of claim 6, further comprising:
a guide unit to prevent the second air from being introduced into the developing unit.

15. The device of claim 6, further comprising:
a guide unit to prevent the second air from being mixed with the first air within the main body.

16. The device of claim 6, wherein the second air is guided from an outside of the main body to another outside of the main body through an inside of the main body.

17. The device of claim 6, wherein the second air is guided from the accumulating unit disposed an outside of the main body to the emitting unit through an inside of the main body to be discharged to another outside of the main body.

18. The device of claim 6, wherein the second heat generated from the printing media is prevented from being transferred to the image reading unit.

19. A multifunctional device comprising:
a main body;
a developing unit disposed inside the main body to form an image on one or more printing media;
an accumulating unit formed on the main body to receive the one or more printing media discharged from the main body to an outside of the main body;
an emitting unit disposed inside the main body to emit heat generated from the developing unit to another outside of the main body; and
a ventilator installed on the accumulating unit to guide air from the accumulating unit to the emitting unit.

20. A multifunctional device comprising:
a main body having cases and a sidewall formed on a portion of the cases;
a developing unit disposed inside the main body to form an image on one or more printing media;
an accumulating unit defined by the sidewall of the main body to receive the one or more printing media discharged from the main body to an outside of the main body; and
a ventilator installed on the sidewall of the accumulating unit to guide air from the accumulating unit to an inside of the main body, the air containing heat generated from the one or more printing media.
